(19) United States
(12) Patent Application Publication
(10) Pub. No.: US 2005/0193325 A1
(43) Pub. Date: Sep. 1, 2005

(54) Mobile content engine with enhanced features

(76) Inventor: David Lawrence Epstein, El Cerrito, CA (US)

Correspondence Address: FISH & RICHARDSON, PC, 12390 EL CAMINO REAL, SAN DIEGO, CA, 92130-2081, US

(21) Appl. No.: 10/987,449

(22) Filed: Nov. 12, 2004

Related U.S. Application Data
(60) Provisional application No. 60/519,721, filed on Nov. 12, 2003.

(51) Int. Cl. G06F 17/00

(52) U.S. Cl. 715/512; 715/513

(57) ABSTRACT

A special tool for use in manipulating electronic information. A projects are manipulated on the computer, wherein each project may comprise one or more documents that are associated with one another. The contents of the documents can be annotated, in a way which makes that contents took different on viewing. The jumping between the different annotations either in the same documents, or in documents associated with the project, is enabled. When the project is closed, the positions of the frames within the project are saved to a single file, which enables that project to be reconstructed on a different computer. In addition, selection of anything within the document allows automatically sending that information to another program.

### CROSS-REFERENCE TO RELATED APPLICATION TION

This application claims benefit of the priority of U.S. Provisional Application Ser. No. 60/519,721 filed Nov. 12, 2003 and entitled “Unique Features of Meanywhere and the JJ2 Mobile-Content Engine,” the disclosure of which is herewith incorporated by reference.

### BACKGROUND

Personal computers have made it possible to deliver electronic content over a network, such as the Internet. A personal computer allows a software tool called a browser to display specified kinds of Internet content. Internet content relies on one specific kind of content being shareable between a number of different users. Since the data is formatted in a special form for the software tool that is used to view the content, the universe of software tools that are used to view such content in effect creates a de facto standard.

Internet content in HTML can be viewed by virtually any browser. However, certain flavors of HTML may not be compatible with all different browsers.

Browser plug-ins have evolved which allow a browser to handle content which is in forms other than HTML. For example, browser plug-ins can allow viewing Adobe Acrobat (PDF) files, and also viewing and/or executing certain kinds of Java programs.

The content on the Internet is often found using a search engine, such as Yahoo or Google. The user may want to save such content. The saving can be carried out by cutting and pasting the content from the browser into an editor, especially if only part of the web page is interesting to user. If the whole web page is interesting, then that whole web page can be bookmarked.

The users can also share the content with others, for example by sending an e-mail to a friend, or using a tool embedded on the web page to send the link to a friend.

### BRIEF DESCRIPTION OF THE DRAWINGS

These and other aspects will now be described in detail with reference to the accompanying drawings, wherein:

FIG. 1 shows a block diagram of a computer;

FIG. 2 shows an overall operational flowchart;

FIG. 3 shows different components of the tool;

FIG. 4 shows a flowchart of automatic capture;

FIG. 5 shows a flowchart of annotating;

FIG. 6 shows a flowchart of saving a desktop and restoring it;

FIGS. 7-10 shows screenshots of capturing; and

FIG. 11 shows a screenshot of highlighting.

### DETAILED DESCRIPTION

Multiple embodiments are described herein.

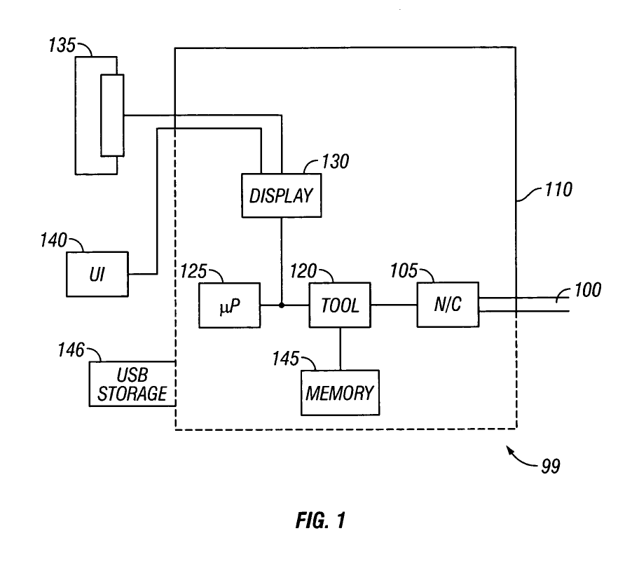

A mobile content engine which allows viewing of content delivered over the Internet, and a special tool running on a personal computer is described first. FIG. 1 shows a basic block diagram of the system 99. Content is sent and received over network 100, which may be the Internet or some other publicly available network, or any other network or channel. The content is received by an interface, usually a network card 105 within a personal computer 110. Information from the network card is interpreted by a software tool 120, which is driven by a microprocessor 125 within the computer. A display driver 130 formats information from the display, and may output that information for display on a display screen shown as 135. A user interface 140 also receives information input from the user. Information may be stored in a memory 145, which may be a combination of persistent and nonpersistent storage. The software tool 120 drives the different functions which are described herein.

In the disclosed embodiment, this system may be used in an educational classroom with a teacher and students, with the teachers and students being either in the same physical location or alternatively in a virtual classroom, in which the teachers and students are remote from one another. It should be understood, however, that the disclosed techniques may be used in any data sharing situation, or situation in which multiple computers are used for the same project.

For example, this can be used in the work environment, to allow users to bring their work home, or to another location. It can also be used with any kind of document, e.g. a WORD™ document, a web-based document such as a webpage; any kind of editable document, such as a powerpoint or excel spreadsheet, with email, or any other kind of electronic content that can be saved in a file, referred to herein as a document.

The tool 120 described herein may be a software tool written in Java, since Java has many functionalities which may be used to advantage by this tool. However, the tool 120 may also be written in any other programming language. The tool 120 may alternatively be implemented by hardware, such as in a field programmable gate array.

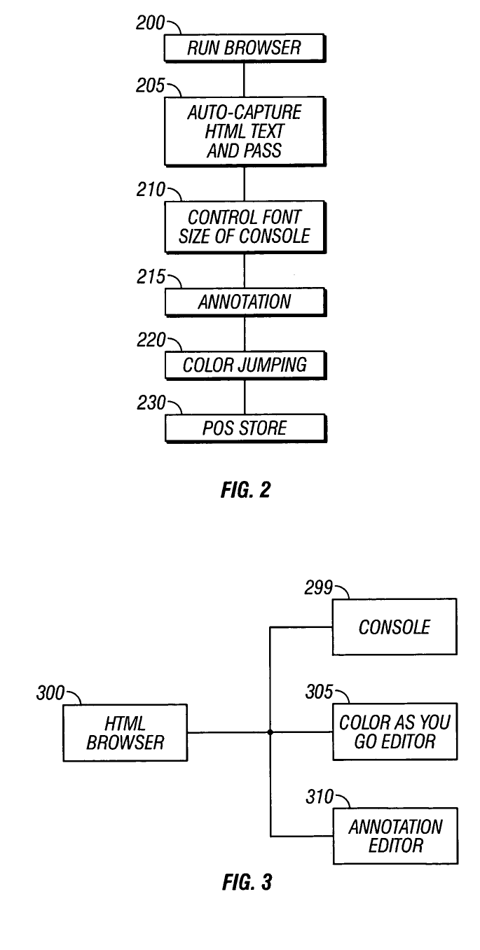

FIG. 2 shows an overall flowchart of operation, and FIG. 3 shows a block diagram of the different parts of the tool.

At 200, a Java-based browser and editor tool is operated to view the content of web pages. The browser may be embedded inside other software, or totally separate from other software. The browser may display any kind of Java objects, including clickable buttons, text, pictures and HTML text and tags. Selection of any item within the browser selects not only the text itself, but also its annotations and attributes, which may include color, highlighting, font and style, and the like.

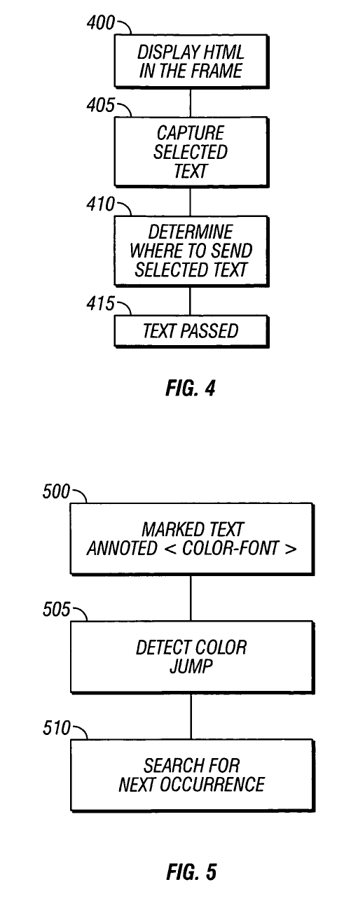

A first feature of this browser is its ability to capture selected text from an HTML document. 205 shows capturing the selected text. FIG. 4 shows further details. An internal frame in the IDE is capable of displaying HTML at 400. Java has an embedded functionality allowing creation of an object called JInternalFrame which meets this requirement. Any time the user selects text at 405, this text is automatically captured. For example, when using the frame object noted above, any selection of text automatically calls the Java method getSelectedText( ). The selected text can then be adaptively captured and sent to a desired object.

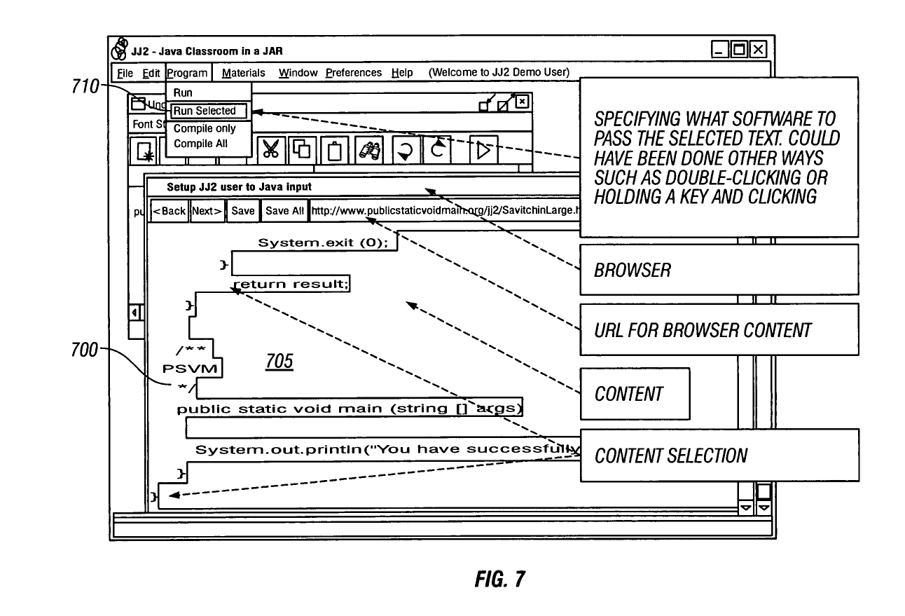

Whenever text is selected, one of the options in the browser allows the option of “Run selected”. FIG. 7 shows an example screen shot of the browser and its RUN SELECTED option. The browser window 700 displays content generally shown as 705.

FIG. 7 shows that a portion of this content has been selected. Selection of the content allows the RUN SELECTED option 710 to become active. While this describes selecting an option such as run selected option, it should be understood that any technique can be used to indicate that an action should be taken on the selected text. For example, alternatives may include double-clicking, or any specific hotkey. Alternatively, a specific function key or a dedicated RunSelected button may be assigned.

Once selecting the text, and invoking the RunSelected option in any of these ways, the tool automatically determines where to send the information. This may be done in one of a number of different ways. For example, a set-selection-software menu item may be used to specify which software will be run, as part of setup of the software. Alternatively the system can search the selected text for keywords, and use those words to determine automatically where to send the information.

If the system finds only text or HTML within the highlighted section, then it may be automatically passed to an appropriate editor. If the tool finds text that indicates programming languages, such as valid Java commands within the selection, it may be executed. Alternatively, special indicia may be embedded within the selection, e.g., an HTML tag indicating that a portion of a document represents executable code, or editable text, or in some other way represents where the data should be sent.

Color or other annotation (BOLD or italic or font type (officially, “font family”) and/or font size may also be used as signals of where the text should be sent. For example, the user may establish defaults. One example default might be that anything that is highlighted in yellow should be sent to a Java compiler. Anything highlighted in blue should be automatically read out loud.

FIG. 7 shows a document in an HTML browser that includes programming language therein, being passed automatically to a Java processor (e.g., the Java Virtual Machine).

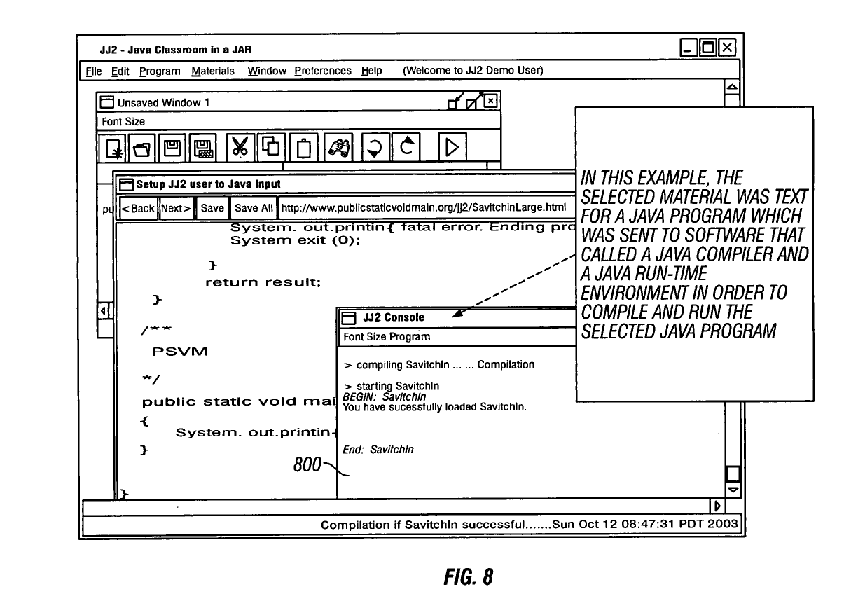

FIG. 8 shows how the selected text within the document is compiled by the Java processor in window 800, and the program is run. Of course, the content of the document can be any content. Alternatively, for example, a picture within a document can be selected, bringing up a picture viewer.

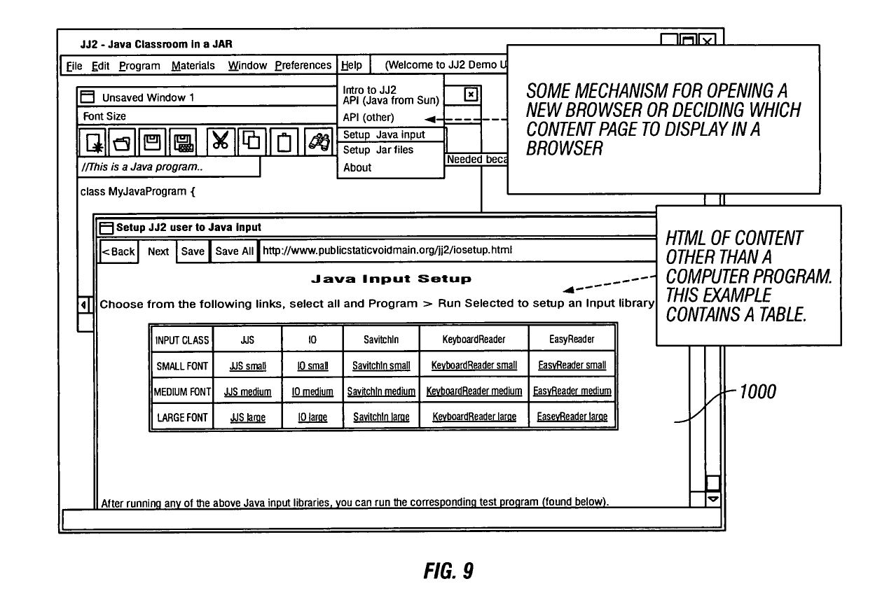

FIG. 9 shows an HTML table 1000, which is automatically saved within an HTML editor, or a WORD-type editor.

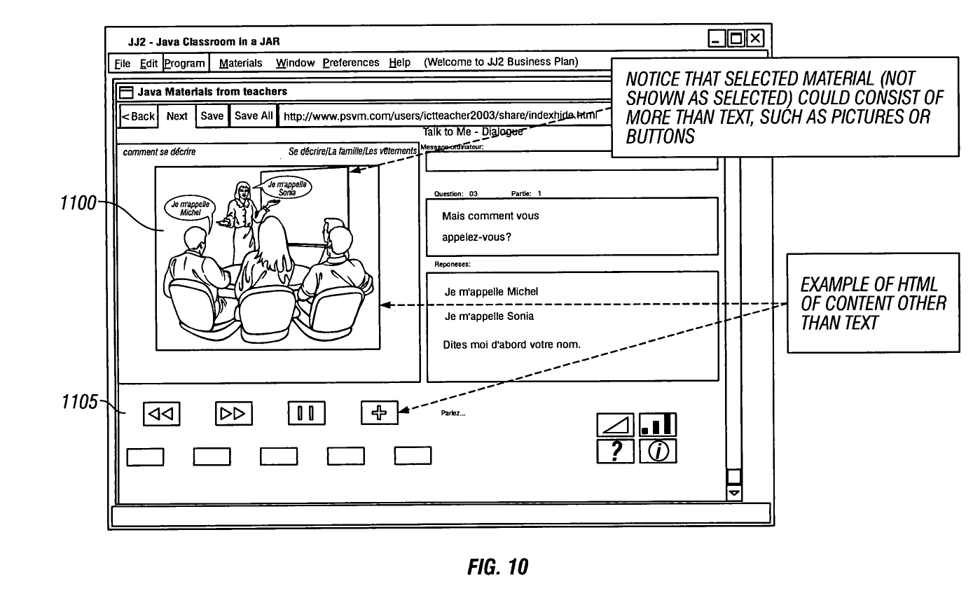

FIG. 10 shows certain browser content other than text, including a picture 1100. The browser content also includes buttons such as 1105. These may be also passed to the editor to provide a more specific picture of the displayed window. The run selected could also be used in an email—to obtain the text, or picture or any other content from the email.

More generally, after making the determination at 410, the text is passed at 415 to the desired program. This can be carried out for example by passing the text to the tool itself, or to the Java compiler. In one example, when executable text is found within the selected text, then the Java compiler is automatically called using a call of the form:
IF (EXECUTABLE JAVA COMMANDS FOUND) THEN CALL JAVA VM (TO EXECUTE THE COMMANDS)

This technique may allow a significant savings in mouse clicks, compared to present systems. Today, to do this, one would have to:
1. Browser+Mouse: Click on the start of the program in the HTML document and hold the mouse button.
2. Browser+Mouse: Drag the mouse over the entire program in the HTML document.
3. Browser+Mouse: Release the mouse, completing the selection of the program.
4. Browser+Mouse: Right-click the mouse and choose the “Copy” option, or use the hotkey “Ctl C”.
5. Windowing (Mouse or Keyboard): Find the appropriate window for editor or IDE.
6. Editor+Mouse: Right-click the mouse and choose the “Paste” option, Ctrl-V or Command-V (Apple) to “Paste” the text from the clipboard.
7. Editor+Mouse or Keyboard: Choose the appropriate steps (either one or two steps) to compile and run the program. Most Editors and IDEs require a click to compile and then another click to run, but some will do both with one click.

Using the embodiment disclosed above,
1. same as above
2. same as above
3. same as above
4. Compile and run the program by selecting the Run-Selected option in the tool. This is similar to step 7 above. This may entail, however, a savings of 3 clicks. Steps 4, 5, and 6 have been removed from the task of running a computer program that has been included in an HTML document.

The code can be run not only from the HTML browser 300, but also from editors that may be part of the tool. The tool may include a first editor, referred to herein as a color as you go editor 305. A second editor is an annotation editor 310. Annotation editor may also be used to color the text, but does not color anything until the user decides to use it for coloring.

A Java console 299 is also present. The Java console has been conventionally used for passing messages back-and-forth to the Java program; and to gather input and output messages, as well as display status and error messages, when any Java program is running. In previous tools, the console has been used for passing data to and from the program. In this system, however, the console may actually be used for an additional function of displaying certain kinds of information, for example in a classroom context. 210 enables controlling the font size and/or color of text displayed on the console. In this way, the already-existing console can be used as an display element.

210 is implemented by adding a menu to the console that lists the font and/or settings as submenu items. However, unlike a conventional editor, selection of a font size and/or color from the menu item causes all text currently inside the console, and all future text, to be changed to that specific font. This can be done, for example, by linking the font command to select all text, and then to a Java setFont( ) method. Using different color for input and output could enable a rerun of the program, using the same input, and verifying that the result is the same output. This might be potentially useful, for example, for teachers who want to grade students' work automatically.

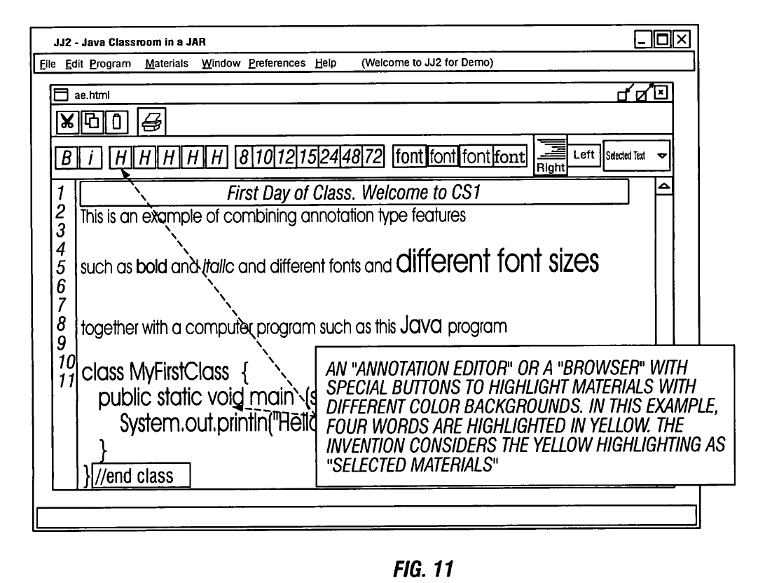

The annotation editor 310 is shown in further detail in FIG. 11. The annotation editor may have special buttons to allow highlighting materials with different colored backgrounds. For example, an annotation operation at 215 may allow formatting in special ways. The annotation editor starts by allowing annotated text to be selected, and then selecting the annotation to be applied to the text. The annotation can also be used to change the font or attributes of the font. In addition to being annotated, the text can be automatically passed to a software program as described above. The passing to the program can include the annotation information. For example, the text can be passed with yellow color, where that yellow color may have meaning as an input to the software tool. More generally, the specific color of any annotation editor at 215 may have meaning to an external software that receives the text.

FIG. 5 shows how marked text may be annotated using HTML tags shown generically as <color-font>. This HTML tag may be used both for display, and also as described herein for document navigation. Other tags, more generally, any kind of xml tag or any other kind of tag may be alternatively used.

220 represents one of the possible operations: the operation of color jumping. More generally, this describes Hypertext linking that is based on annotations, such as color. The following describes the operation with color as the annotation.

Once color annotations have been added at 215, these color annotations form highlighters for the text that can be used to link to other parts of the document.

Different parts of the document which relate to different subjects can all be highlighted in the same text. A user interface actuation, such as a mouse click, can then be used to jump from one of the occurrences of a specified color to a next occurrence of that specified content, either in the specified document, or in another document. This can be used within an HTML document, within a presentation, or in any other document. This may be especially useful in a collaborative environment.

FIG. 5 shows annotated text at 500, and color jumping detected at 505. The color jumping command can simply be a mouse click, or can be a specified actuation of any kind. Color jumping comprises a search for the next occurrence of the specified annotation.

For example, if the cursor is on a text indicating yellow highlighting, then a mouse click causes, at 505, a search for the next occurrence of yellow highlighting within the document. This may include scanning all the way to the end of the document, looking for the next matching color highlight, and storing whatever color highlight is found as the new position for the cursor. This is followed by setting the cursor to the new position, thereby causing automatic scrolling to that position. This can also be implemented in a web page or in any other tool that displays a document.

In an embodiment, when the end of one document is reached, specified other documents can also be searched for the specified annotation. For example, different documents which are in the same folder or project can also be searched for the annotation. In this way, a specified collection of documents can be similarly annotated. The user can then find the annotated versions in any of those documents using the color jumping technique.

The above has described marking with HTML tags, but it should be understood that any marking can be used for this purpose, and specifically anything that indicates an annotation mark can be used and then later used for searching commands.

The tool that does the color jumping must be compatible with the tool that does the annotation, and hence they are shown in the same flowchart of FIG. 5. However, separate tools can actually be used as long as they are compatible, e.g., in the same format. It is contemplated that the tags could use special HTML tags such as

<COLOR-HIGHLIGHTING-COLOR = YELLOW> AND
</COLOR-HIGHLIGHTING-COLOR = YELLOW>

as start and end tags respectively surrounding the content to be highlighted. Alternatively, however, the standard tags which are used within an HTML document for changing its color or highlighting can be used. A program can automatically highlight aspects within a document.

In another embodiment, rather than storing the tags within the specific section of the document, either a separate section, a separate document, or some other location, may be used to store the different highlighting information. For example, a list of highlighted sections can be stored within an HTML comment as, for example:

<!_ COLOR HIGHLIGHTING: YELLOW = { (14, 23), (134 178) };
BLUE= { (50, 55) }; -->.

The search for next occurrence at 510 requires reading a current annotation, and searching for the position of the next annotation of the same type. The values for color start and color end supply information used to jump to the next position in the content that has the same color highlighting. Again, this is done by looking for the tag or other annotation, noted as having the same next color highlighting and then automatically scrolling the text to the position.

230 in FIG. 2 represents the project storage operation. The tool organizes the work which is being done as “projects”. Each file that is part of the Project is open inside a particular project directory on the computer. This facilitates making the user's work more portable.

In operation, positions of all open windows, called “frames” in Java, are stored; for example, the (x,y) of the upper left point, its height and width, and a name of the file (if necessary), is stored. For example, if the frame is an editor, then the name of the file that is currently being edited is also stored. Storage of the x,y, width, height and filename of the file being edited allows reconstructing the exact frame that was seen by the user, at some later time.

Browser windows are stored in an analogous way. Each browser is stored with its current URL, as well as a History of URLs for the Back and Next buttons. All this data is stored as the “state of the browser”. The browser's position and URL list x,y; width, height; URL history; and pointer into the URL history which is usually on the end, unless the most recent clicks were on Back or Next buttons, are stored. As an example, consider a file that has the following contents:

TYPE=JJ2BROWSER
X=67
Y=104
HEIGHT=200
WIDTH=400
URLHISTORYLIST={
“HTTP://WWW.GOOGLE.COM”,“HTTP://WWW.YA

HOO.COM”}

URLHISTORYPOINTER=1

The first line means that the “saved” object is a JJ2Browser. The rest indicates where to put it, how big it is, the content of the History URLs are as well as the current web page (current URL).

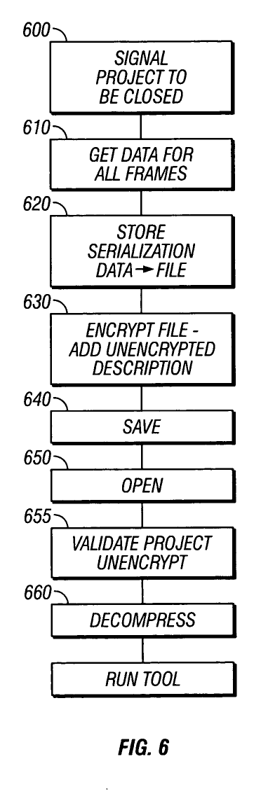

The operation is shown in the flowchart of FIG. 6.

The tool stores certain information together, as a project. All of the files and information that is needed for a specified task are associated together in some way. The files may simply be named similarly, or may be saved within a special folder. The files which define the project are described in further detail herein. However, all files and/or documents within a specified project are associated with one another in some way.

In the color jumping embodiment described above, color jumping may be enabled between any of the documents in the same project. This embodiment, however, describes how a project is opened or closed and how the state of the project can be saved. At 600, the user signals that a Project should be closed. At 610 the tool goes through all the open frames for the project, and “serializes” those frames to store information from which each frame can be reconstructed.

This is done by storing the position for each frame, for example the upper-left x and y coordinate, and the height and the width of the frame. Frame-specific information, such as the filename or an editor, and the URL-History for a browser, is also stored. Other frames may store different kinds of information. For example, an email frame may store information indicative of recently read emails, or recently-used email addresses.

At 620, the data from the serializing of the open frames is stored as a file (for example, desktop.ser) in the project folder. The project folder can then be packaged and compressed into one file.

At 630, the file can be encrypted based on the username and password. A header line describing the project is added. This includes information such as username and project name. This can allow looking at that header line in order to determine the project that is associated with the file.

At 640 the user can choose to save the file, either to disk or to a server.

650 starts the reverse process, where the user decides to open a Project, specifying if they want to open “a Project off the server” or “a local Project”.

At 655, the header is used to validate the description of the Project (for example, the user name), and a password is used to decrypt the Project.

The decrypted Project is uncompressed at 660. The contents of the file are used at 665 to form the Project folder, with a desktop that looks like the desktop when it was closed in 600.

At 670, the tool is now running, with the restored Project folder and the restored Project desktop.

In an educational application, this feature may be particularly useful, as the user can quickly save the contents of the desktop when the class is over. There is no need to gather all the work and e-mail it to oneself. The tool storage information may be stored on a removable storage device such as the USB storage device shown as 146 in FIG. 1. The data can also be uploaded to an online account.

One important feature includes allowing this operation is to keep all the classes serializable. Serializability of a class is enabled by the class implementing the java.io.Serializable interface. Some actual exemplary code follows:

//BEGIN CODE

PUBLIC CLASS GUISTATE IMPLEMENTS SERIALIZABLE,

STORABLE {

//STORE THE POSITION OF A WINDOW (ALL WE NEED
IS UPPER

LEFT (X,Y) AND THE HEIGHT AND WIDTH

PRIVATE DOUBLE WIDTH;
PRIVATE DOUBLE HEIGHT;
PRIVATE DOUBLE XPOS;
PRIVATE DOUBLE YPOS;
//...
//MANY LINES REMOVED...
//...
PUBLIC VOID WRITETO(OUTPUTSTREAM OUT)
THROWS
IOEXCEPTION {
OBJECTOUTPUTSTREAM OOS = NEW
OBJECTOUTPUTSTREAM(OUT) ;
OOS.WRITEOBJECT(THIS) ;
}
PUBLIC STORABLE READFROM(INPUTSTREAM
IN)
THROWS IOEXCEPTION {
OBJECTINPUTSTREAM OIS = NEW
OBJECTINPUTSTREAM(IN) ;
TRY {
GUISTATE GS = (GUISTATE)
OIS.READOBJECT( ) ;

RETURN GS;
} CATCH (EXCEPTION EX) {
SYSTEM_ERR.PRINTLN(“EXCEPTION
WHILE

READING DESKTOP:

”+EX) ;

RETURN NULL;
}
}

//...
//MANY LINES REMOVED...
//...
//END CODE

In this way, the runtime objects, containing all the information needed to seamlessly duplicate the frames that a user was seeing, is serialized and written to disk.

All of the information can be stored in any format, but may be most conveniently stored in some kind of XML format where each XML tags represents a different aspect that needs to be reconstituted.

All of the different information is preferably stored into a single file. Any compression utility, such as the Java jar utility, pkzip, or any other utility that encapsulates multiple files into one file, such as rar or toast archivers, can alternatively be used.

As an alternative to the above, the user name and current date on log out may be stored as part of the filename for the file. This allows the user to see the time and day where they last logged on.

Although only a few embodiments have been disclosed in detail above, other modifications are possible.

The above has used many terms, that may be interpreted according to their normal meaning. In addition, however:

Document is any electronic file having readable words therein, for example, in editable text or word processing form, or in HTML, or in email format, or any other format.

Computer Program: A series of instructions which follow the rules of a programming language. A computer program is typically created with an “editor” such as the Notepad editor that comes with the Windows Operating System or an editor that comes with a programming IDE (Integrated Developer's Environment).

Software tool: A series of instructions from a program and not necessarily the entire program.

Compile: Verify that the computer program abides by the rules of the programming language, and if so, take the necessary steps so that the program can be “run”.

Compiler: A software tool capable of compiling a computer program.

HTML: A Hyper-Text Markup Language for specifying (1) markup, how a document looks when viewed in a browser, and (2) hyper-text, what document should next be displayed in a browser should a “link” be clicked.

Browser is a software tool capable of displaying HTML pages or other documents in other formats.

Content: electronic data, typically stored in a computer file, but also including materials available on the Internet.

Only claims which use the word “means” are intended to be interpreted with respect to 35 USC 112.

1. A method, comprising:
storing annotations within a document, which annotations represent a signal of a change to a look of least one specified part of the document; and
detecting a jump command, and responsive to said jump command, determining a first annotation associated with said detecting a jump command, determining a next annotation associated with said first annotation, and changing a position of a display to a position of said next annotation associated with said jump command.

2. A method as in claim 1, wherein said annotations are stored as tags within the document, with a first tag representing a beginning of the location of the annotation and a second tag representing an end of the annotation.

3. A method as in claim 2, wherein said annotations within the document represent coloring of text within the document between the beginning of the annotation and the end of the annotation.

4. A method as in claim 3, wherein said annotations within the document comprise HTML tags.

5. A method as in claim 1, wherein said annotations comprise an indication of a desired annotation and an indication of a location for the annotation within the document, and wherein a location of said annotations are in a location of the document that is separate from a location of at least one annotation.

6. A method as in claim 5, wherein said annotations include a color for selected text, and further comprising displaying the text associated with the annotation, in the selected color.

7. A method as in claim 5, further comprising displaying the text in a way that is changed based on said annotations.

8. A method as in claim 1, wherein all objects within the document are serializable.

9. A method as in claim 8, further comprising storing information about a current user environment, including at least a content of the document, and a size and position of a frame storing the document.

10. A method as in claim 9, wherein said storing comprises storing all of said information into a single file.

11. A method as in claim 1, wherein said first annotation comprises an annotation that exists at a position of viewing when the jump command is executed.

12. A method as in claim 1, wherein said second annotation comprises a same kind of annotation type as the first annotation.

13. A method as in claim 11, wherein said second annotation comprises a next occurrence of the same type of annotation type as the first annotation.

14. A method as in claim 1, further comprising enabling text to be selected by a software tool, detecting actuation of the selected text, and automatically passing the selected text to another program based on said actuation.

15. A method as in claim 14, wherein said automatically passing comprises automatically determining said another program based on content of the selected text.

16. A method as in claim 1, wherein said first and second annotations are within the same file.

17. A method as in claim 1, wherein said first and second annotations are within different files.

18. A method, comprising:
determining, on a computer, current contents of frames that are displayed on the computer, where said current contents of frames include at least positions of each of a plurality of frames on the desktop, sizes of each of the plurality of frames, content of each of the plurality of frames, and history information for at least one of said plurality of frames;
producing data representing said current contents of said frames, and
forming a single file that represents said data as representing a current content of the computer.

19. A method as in claim 18 wherein at least one of said frames on said computer comprises a browser.

20. A method as in claim 19, wherein said browser is capable of allowing annotations to contents of a document being displayed in said browser, and further comprising detecting a command to jump annotations, and in response to said command, detecting a content of a current annotation, finding a next annotation having the same content within the document, and moving a current position of said display to said next annotation automatically.

21. A method as in claim 20, wherein said annotations include colors, and wherein said browser displays text associated with said annotations based on a color indicated by the annotation.

22. A method as in claim 19, further comprising allowing text to be selected, and automatically passing selected text to another program.

23. A method as in claim 18, wherein said forming a single file comprises compressing the data into the single file.

24. A method as in claim 18, further comprising using the single file on another computer to reconstitute said current content of said frames on said another computer.

25. A method, comprising:
storing a plurality of information associated with a project associated with other information associated with the project;
detecting a request to close a project;
determining information about locations and sizes of frames defining the project, as well as a file name associated with the frame; and
storing the information and filename into a single file for each of the plurality of frames, said single file representing the project information.

26. A method as in claim 25 wherein said information further includes a history of viewed web sites, and a position of current viewing within the history.

27. A method as in claim 25, wherein said information further includes e-mail information.

28. A method as in claim 15, further comprising opening a project by using said single file to retrieve said information, and using said information to reconstruct the frames.

29. A method as in claim 25, wherein the project further allows annotations within the project, and a jumping selection which enables jumping from a first annotation in the project to a second annotation in the project.

30. A method as in claim 29, wherein said first annotation and said second annotation are the same kind of annotations.

31. A method as in claim 25, wherein the project further allows selecting text within the document, and automatically passing the text to another program.

32. A system, comprising:
a computer executing a first routine to allow viewing a document, said document having annotations within the document, which annotations represent a signal of a change to a look of least one specified part of the document; and
said computer detecting a jump command, and responsive to said jump command, determining a first annotation associated with said detecting a jump command, determining a next annotation associated with said first annotation, and changing a position of a display to a position of said next annotation associated with said jump command.

33. A system as in claim 32, wherein said computer stores said annotations as tags within the document, with a first tag representing a beginning of the location of the annotation and a second tag representing an end of the annotation.

34. A system as in claim 32, wherein said annotations within the document represent coloring of text within the document, and wherein said computer displays colored text between the beginning of the annotation and the end of the annotation.

35. A system as in claim 34, wherein said computer stores the annotations within the document comprise HTML tags.

36. A system as in claim 32, wherein said computer stores annotations as an indication of a desired annotation and an indication of a location for the annotation within the document, and wherein a location of said annotations are in a location of the document that is separate from a location of at least one annotation.

37. A system as in claim 36, wherein said computer stores annotations that represent a color for selected text, and further comprising a display which displays the text associated with the annotation, in the selected color.

38. A system as in claim 37, wherein the display displays the text in a way that is changed based on said annotations.

39. A system as in claim 32, wherein said computer determines information including at least a content of the document, and a size and position of a frame storing the document, and stores said information.

40. A system as in claim 39, wherein said computer stores all of said information into a single file.

41. A system as in claim 32, wherein said first annotation comprises an annotation that exists at a position of viewing when the jump command is executed.

42. A system as in claim 32, wherein said second annotation comprises a same kind of annotation type as the first annotation.

43. A system as in claim 41, wherein said second annotation comprises a next occurrence of the same type of annotation type as the first annotation.

44. A system as in claim 43, wherein said computer enables text to be selected by a software tool, and detects actuation of the selected text, and automatically passes the selected text to another program based on said actuation.

45. A system as in claim 44, wherein said computer automatically determines said another program based on content of the selected text.

46. A system as in claim 1, wherein said first and second annotations are within the same file on said computer.

47. A system as in claim 1, wherein said first and second annotations are within different files on said computer.

48. A system, comprising:
a computer, including a display driver that produces an output indicative of display of a plurality of frames,
said computer detecting current contents of frames that are displayed, where said current contents of frames include at least positions of each of a plurality of frames on the desktop, sizes of each of the plurality of frames, content of each of the plurality of frames, and history information for at least one of said plurality of frames, produces data representing said current contents of said frames, and forms a single file that represents said data as representing a current content of the computer.

49. A system as in claim 48 wherein at least one of said frames on said computer comprises a browser.

50. A system as in claim 49, wherein said browser is capable of allowing annotations to contents of a document being displayed in said browser, and said computer detects a command to jump annotations, and in response to said command, detects a content of a current annotation, finds a next annotation having the same content within the document, and moves a current position of said display to said next annotation automatically.

51. A system as in claim 50, wherein said annotations include colors, and wherein said computer displays text associated with said annotations based on a color indicated by the annotation.

52. A system as in claim 49, further comprising a part on said computer that allows text to be selected, and said computer automatically passes selected text to another program.

53. A system as in claim 48, further comprising a port on said computer, allowing said single file to be stored on an external medium that is coupled to said port.

54. A system as in claim 48, further comprising another computer, reconstituting said current content of said frames based on said data.

55. A system, comprising:
a memory, storing a plurality of information associated with a project associated with other information associated with the project;
a user interface, enabling a request to close a project;
a computer, associated with said memory and said user interface, and determining information about locations and sizes of frames defining the project, as well as a file name associated with the frame, and storing the information and filename into a single file for each of the plurality of frames, said single file representing the project information.

56. A system as in claim 55 wherein said information further includes a history of viewed web sites, and a position of current viewing within the history.

57. A system as in claim 55, wherein said information further includes e-mail information.
